(19) United States
(12) Patent Application Publication
(10) Pub. No.: US 2025/0217960 A1
(43) Pub. Date: Jul. 3, 2025

(54) DEFECT REGION DETECTION DEVICE AND WAFER DEFECT DETECTION SYSTEM INCLUDING THE SAME

(71) Applicant: Samsung Electronics Co., Ltd., Suwon-si (KR)

(72) Inventors: Minsu Kim, Suwon-si (KR); HIDONG KWAK, Suwon-si (KR); Jeongho Ahn, Suwon-si (KR)

(21) Appl. No.: 18/772,694

(22) Filed: Jul. 15, 2024

(30) Foreign Application Priority Data
Dec. 27, 2023 (KR) 10-2023-0193526
Jan. 19, 2024 (KR) 10-2024-0008967

(51) Int. Cl. G06T 7/00; G01N 23/2251; G06T 7/90

(52) U.S. Cl. CPC G06T 7/0006; G01N 23/2251; G06T 7/90; G01N 2223/401; G01N 2223/6116; G06T 2207/10024; G06T 2207/10061

(57) ABSTRACT

Disclosed is a defect region detection device which includes a measuring unit that measures pattern information in one or more pattern regions based on a pattern image including the one or more pattern regions and generates gauge data, and a color mapping unit that maps a color corresponding to the gauge data to each of the one or more pattern regions based on the pattern image and the gauge data and generates a color mapping image. The defect region detection device detects a defective region based on the color assigned to each of the one or more pattern regions of the color mapping image.

### CROSS-REFERENCE TO RELATED APPLICATIONS

This application claims priority under 35 U.S.C. § 119 to Korean Patent Application Nos. 10-2023-0193526 filed on Dec. 27, 2023, and 10-2024-0008967 filed on Jan. 19, 2024, in the Korean Intellectual Property Office, the disclosures of which are incorporated by reference herein in their entireties.

### BACKGROUND

Embodiments of the present disclosure described herein relate to a wafer defect detection system, and more particularly, relate to a device and a method for detecting whether a defect is present in a wafer, based on a pattern image of a pattern formed on the wafer.

A technology for forming a circuit pattern on a silicon wafer is a core technology in semiconductor processes. As a semiconductor process technology becomes more advanced and a line width become finer, types of defects and the amounts of defects are increasing exponentially. For this reason, technologies for detecting defects of a semiconductor device are being developed. For example, technologies for detecting defects of a semiconductor device by using a scanning electron microscope (SEM) image obtained by measuring a pattern projected and formed on a wafer through an inspection device have been researched. However, it is difficult to easily identify a region of the wafer, at which a defect occurs, by using only a gray scale color of the SEM image.

In addition, problems to be solved by the technical idea of the present disclosure are not limited to the problem mentioned above, and other problems may be clearly understood by one skilled in the art from the description below.

### SUMMARY

Embodiments of the present disclosure provide a device capable of easily checking a defective region on a wafer.

According to an embodiment, a defect region detection device includes a measuring unit configured to generate gauge data, based on a pattern image including a plurality of pattern regions, by measuring pattern information in one or more of the pattern regions; and a color mapping unit configured to generate a color mapping image, based on the pattern image and the gauge data, by mapping a color corresponding to the gauge data to the one or more pattern regions, wherein the defect region detection device is configured to detect a defective region based on the color assigned to the one or more pattern regions of the color mapping image.

According to an embodiment, a wafer defect detection system includes a measurement device that obtains a scanning electron microscope (SEM) image by scanning a wafer with a beam of electrons, and a defect region detection device that detects a defect of a pattern formed on the wafer based on the SEM image. The defect region detection device includes a measuring unit configured to generate gauge data, based on a pattern image including a plurality of pattern regions, by measuring pattern information in one or more of the pattern regions; and a color mapping unit configured to generate a color mapping image, based on the pattern image and the gauge data, by mapping a color corresponding to the one or more of pattern regions.

According to an embodiment, a computer program that is stored in a storage medium, when is executed by a computer, causing the computer to measure pattern information in one or more pattern regions based on a pattern image including the one or more pattern regions to generate gauge data, to map a color corresponding to the gauge data to each of the one or more pattern regions based on the pattern image and the gauge data to generate a color mapping image, and to detect a defective region based on the color assigned to each of the one or more pattern regions of the color mapping image.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The above and other objects and features of the present disclosure will become apparent by describing in detail embodiments thereof with reference to the accompanying drawings.

FIG. 1 is a diagram illustrating a wafer defect detection system according to an embodiment of the present disclosure.

FIG. 2 is a block diagram illustrating an embodiment of a defect region detection device of FIG. 1.

FIG. 3 is a flowchart illustrating a defect detection method performed by a defect region detection device of FIG. 2.

FIG. 4 is a diagram illustrating an example of a pattern image.

FIGS. 5A to 5C are diagrams illustrating an example of a defect detection method performed for a pattern image of FIG. 4.

FIGS. 6A to 6C are diagrams illustrating another example of a defect detection method performed for a pattern image of FIG. 4.

FIG. 7 is a diagram illustrating another example of setting a pattern region in operation S110 of FIG. 3.

FIG. 8 is a diagram for describing a defect detection method according to an embodiment of the present disclosure.

FIG. 9 is a diagram for describing how a defective region is detected in an example of a pattern image, according to an embodiment of the present disclosure.

FIG. 10 is a diagram for describing how a defective region is detected in another example of a pattern image, according to an embodiment of the present disclosure.

FIG. 11 is a diagram for describing how a defective region is detected in another example of a pattern image, according to an embodiment of the present disclosure.

FIG. 12 is a diagram for describing how a defective region is detected in an example of a pattern image, according to an embodiment of the present disclosure.

FIG. 13 is a block diagram illustrating an implementation example of a defect region detection device according to an embodiment of the present disclosure.

### DETAILED DESCRIPTION

Below, embodiments of the present disclosure will be described in detail and clearly to such an extent that an ordinary one in the art easily carries out the present disclosure.

As used herein, the term “device” or “unit” refers to any combination of software, firmware, and/or hardware configured to provide the functionality described herein. The software may be implemented, for example, as a software package, a code, and/or an instruction set or an instruction, and the hardware may be implemented, for example, with a hardwired circuit, a programmable circuit, a state machine circuit, and/or an assembly or a single or arbitrary combination of firmware that stores instructions executable by a programmable circuit.

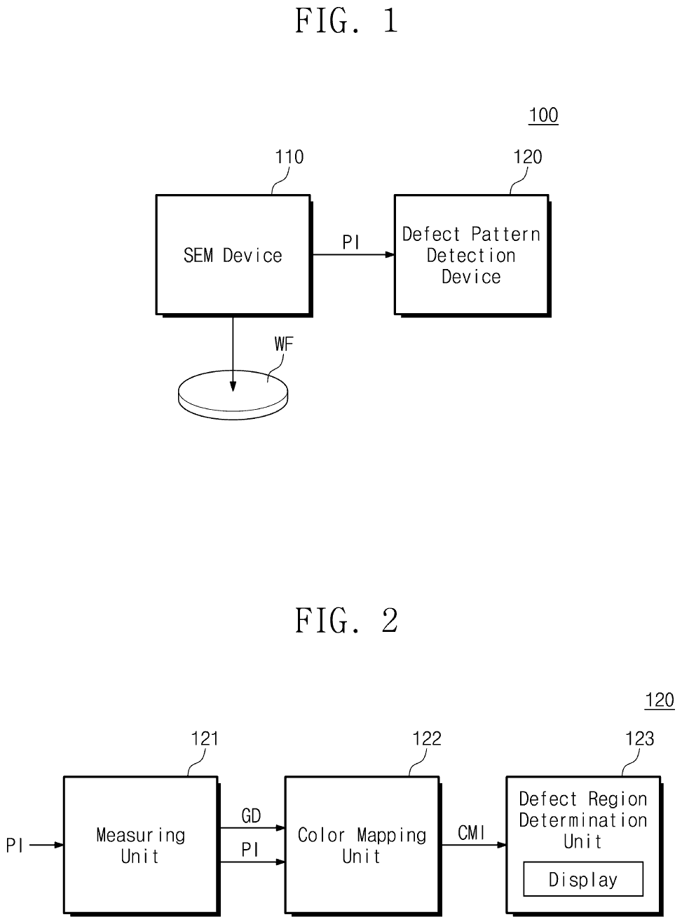

FIG. 1 is a diagram illustrating a wafer defect detection system according to an embodiment of the present disclosure.

Referring to FIG. 1, a wafer defect detection system 100 may include a measurement device 110 and a defect region detection device 120.

The measurement device 110 may scan a wafer WF with an electron beam (E-beam) (or a focused beam of electrons) and may obtain a pattern image PI including information about a pattern formed on the wafer WF. In an embodiment, the measurement device 110 may include a scanning electron microscope (SEM) device, and the pattern image PI may include a SEM image collected from the SEM device.

The pattern image PI may be a gray scale image capable of being identified by using a representation of the amount (i.e., level or intensity) of light in each pixel of the image through a variation in shades of gray from black to white. For example, the pattern image PI may be an 8-bit image, and the brightness of the pattern image PI may have a value ranging from 0 (black) to 255 (white). The level of the light in the pattern image PI may be determined depending on the amount of electrons collected by the measurement device 110 when the pattern of the wafer WF is scanned with the beam of electrons, that is, depending on a brightness difference of patterns.

The defect region detection device 120 may be configured to detect a defect of the pattern formed on the wafer WF, based on the pattern image PI. The defect region detection device 120 may be configured to measure pattern information in each of a plurality of pattern regions of the pattern image PI, to generate a color mapping image by assigning colors to the plurality of pattern regions based on gauge data GD corresponding to the plurality of pattern regions, and to determine a defective region on the wafer WF based on the color mapping image.

Below, a configuration and an operating method of the defect region detection device 120 will be described in detail.

FIG. 2 is a block diagram illustrating an embodiment of a defect region detection device of FIG. 1.

Referring to FIG. 2, the defect region detection device 120 may include a measuring unit 121, a color mapping unit 122, and a defect region determination unit 123.

The measuring unit 121 may receive the pattern image PI generated by the measurement device 110. The pattern image PI may include a plurality of pattern regions. In an embodiment, the measuring unit 121 may be further configured to set the plurality of pattern regions based on the pattern image PI, and each of the plurality of pattern regions may refer to a unit for measuring pattern information. For example, the measuring unit 121 may be configured to set a size and a shape of a pattern region based on a shape of the pattern on the pattern image PI and to set the arrangement of the plurality of pattern regions.

The measuring unit 121 may be configured to measure pattern information in each of the plurality of pattern regions of the pattern image PI and to generate the gauge data GD. For example, the pattern information may include information about a critical dimension, the size of the area, an overlay, etc. of a pattern included in a pattern region. However, the present disclosure is not limited thereto. For example, the pattern information may further include information about sizes, shapes, arrangement, etc. of patterns.

The gauge data GD may include a plurality of gauged values corresponding to the plurality of pattern regions. For example, when the measuring unit 121 measures the critical dimension as the pattern information, the gauge data GD may include a first gauged value being a critical dimension gauged value of a pattern of a first pattern region, a second gauged value being a critical dimension gauged value of a pattern of a second pattern region, and an n-th gauged value being a critical dimension gauged value of a pattern of an n-th pattern region. Each gauged value may be a value expressed by a numerical value.

The gauge data GD generated by the measuring unit 121 may be provided to the color mapping unit 122 together with the pattern image PI.

The color mapping unit 122 may be configured to generate a color mapping image CMI based on the pattern image PI and the gauge data GD. In an embodiment, the color mapping unit 122 may be configured to generate the color mapping image CMI by mapping a color to each of the plurality of pattern regions based on the gauge data GD of the pattern image PI. In an embodiment, the color may include at least one of red, green, and blue or may be a color expressed by a combination thereof. However, the present disclosure is not limited thereto. For example, the color mapping unit 122 may assign a color by using various color modes with color separation, such as CMYK color space, CIELAB or LAB color space, and indexed color space.

The color mapping unit 122 may determine a kind of a color or a brightness level of a color mapped to each pattern region, based on a gauged value.

In an embodiment, the color mapping unit 122 may assign different colors to pattern regions having different gauged values from among the plurality of pattern regions. For example, within a gradation color range from a first color corresponding to a first value to a second color corresponding to a second value, the color mapping unit 122 may assign a color corresponding to a gauged value to a pattern region having a gauged value included in a range from the first value to the second value.

For example, the first color may include at least one of an 8-bit red, an 8-bit green, and an 8-bit blue or may be a color expressed by a combination thereof, the second color may include at least one of an 8-bit red, an 8-bit green, and an 8-bit blue or may be a color expressed by a combination thereof, and the gradation color range may mean a color range in which each of the red, the green, and the blue increases or decreases from the first color to the second color in units of the given number of bits. For example, in the case where R, G, and B values of the first color corresponding to the first value are 10, 150, and 200 and R, G, and B values of the second color corresponding to the second value are 200, 30, and 100, the gradation color range may include R increasing within a range from 10 to 200, G decreasing within a range from 150 to 30, and B decreasing within a range from 200 to 100.

In an embodiment, the color mapping unit 122 may assign a color to a pattern region depending on a range section to which a gauged value belongs. For example, the first color may be assigned to a pattern region whose gauged value belongs to a first range from the first value to the second value (greater than the first value), and the second color may be assigned to a pattern region whose gauged value belongs to a range from the second value to a third value (greater than the second value).

In an embodiment, the color mapping unit 122 may assign a color indicating a defect region DR to a pattern region whose gauged value is greater than or equal to a threshold value. In another embodiment, the color mapping unit 122 may assign a color indicating a defect region DR to a pattern region whose gauged value is smaller than or equal to the threshold value. In certain embodiments, the defect region DR may be referred to as a defect pattern. For example, when the pattern region PR on the pattern image PI is set such that only a pattern or a portion of a pattern is included within the pattern region PR, the defect region DR may be referred to as a defect pattern.

However, the present disclosure is not limited thereto. For example, it may be understood by one skilled in the art that various colors are able to be mapped to pattern regions based on gauged values of the plurality of pattern regions.

In an embodiment, the color mapping unit 122 may be further configured to assign a color to at least a portion of a pattern region. For example, a pattern region may include a pattern portion, which a pattern targeted for pattern information measurement occupies, and the remaining portion; in this case, the color mapping unit 122 may only assign a color corresponding to a gauged value to the pattern portion, and the color mapping unit 122 may not assign a color to the remaining portion or may assign a specific color to the remaining portion regardless of a gauged value.

The defect region determination unit 123 may be configured to determine a defective (i.e., defect) region based on the color mapping image CMI. In an embodiment, the defect region determination unit 123 may determine a pattern region with a specific color as a defective region. In another embodiment, the defect region determination unit 123 may determine a pattern region, to which a color indicating a defect region is assigned, as a defective region.

In an embodiment of the present disclosure, color mapping may be made depending on pattern information, not the brightness of a gray scale pattern image. Accordingly, whether a defect is present in each of the plurality of pattern regions of the pattern image may be easily detected, and thus, a location of a defective region may be easily identified.

The defect region determination unit 123 may further include a display configured to display the color mapping image CMI. The operator may easily perceive a region of the wafer, at which a pattern defect exists, through the display on which the color mapping image CMI is displayed.

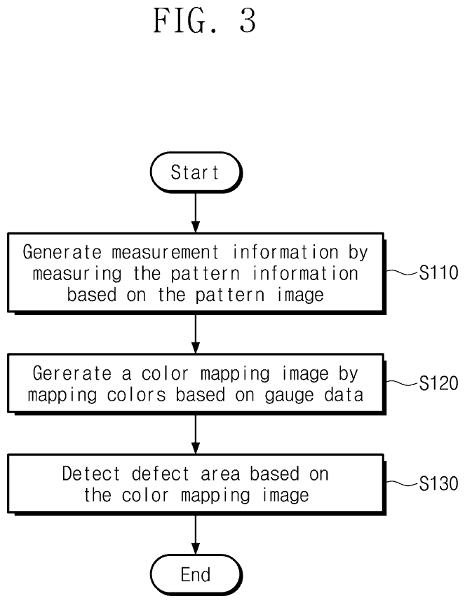

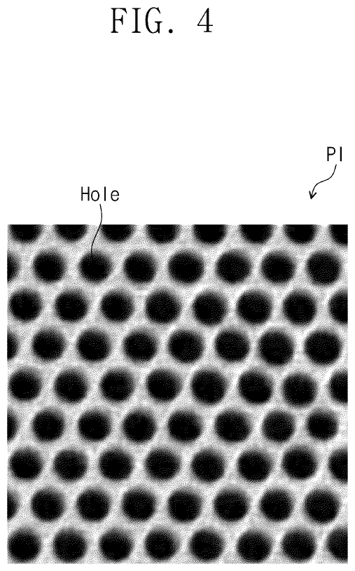

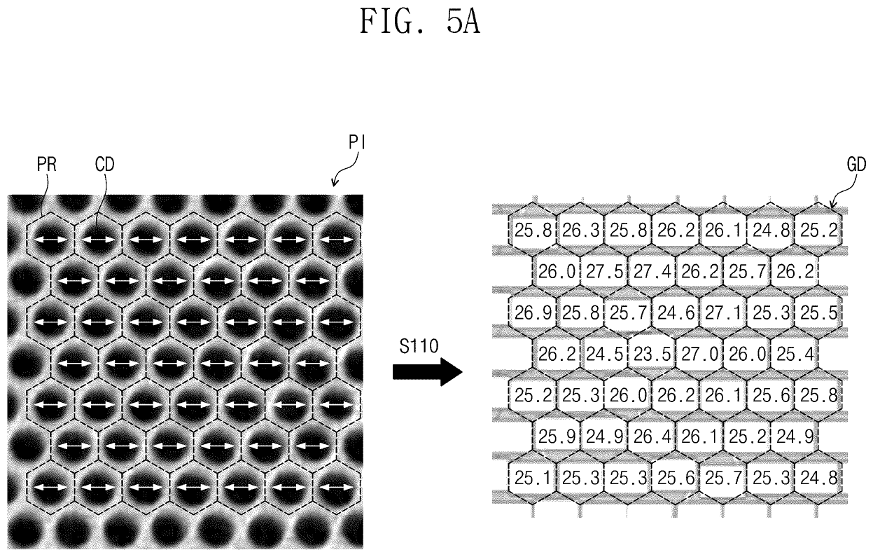

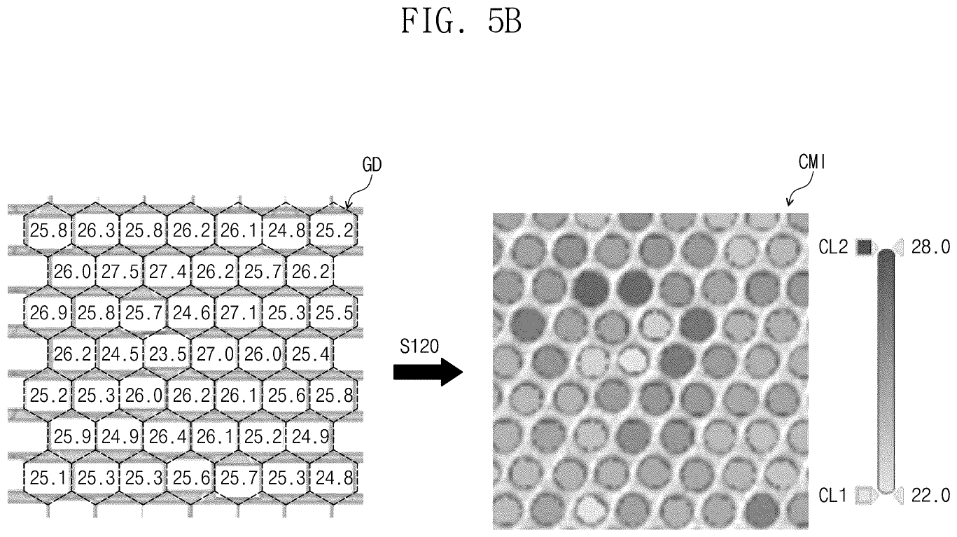

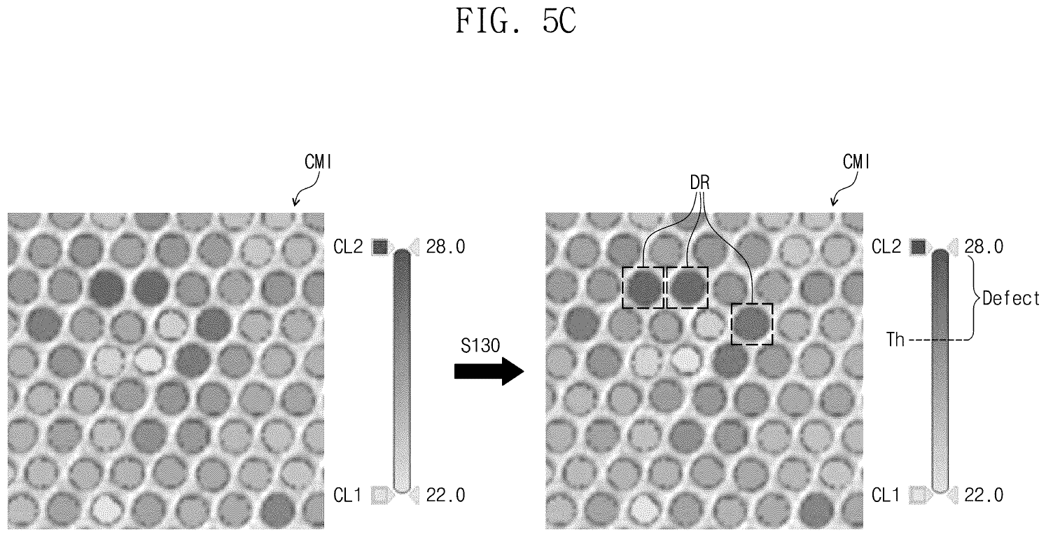

FIG. 3 is a flowchart illustrating a defect detection method performed by a defect region detection device of FIG. 2. FIG. 4 is a diagram illustrating an example of a pattern image. FIGS. 5A to 5C are diagrams illustrating an example of a defect detection method performed for a pattern image of FIG. 4. Below, a defect detection method according to the present disclosure will be described in detail with reference to FIG. 2 together.

Referring to FIGS. 2, 3, and 5A, in operation S110, the defect region detection device 120 may measure pattern information based on the pattern image PI and may generate the gauge data GD.

In an embodiment, the pattern image PI may include a plurality of hole patterns (refer to “Hole” of FIG. 4). The plurality of hole patterns may be spaced apart from each other, may be uniformly arranged, and may be in the shape of a circle.

The measuring unit 121 may set a plurality of pattern regions PR based on the pattern image PI, and each of the plurality of pattern regions PR may refer to a unit for measuring pattern information. For example, each pattern region PR may be set to include one hole pattern. Two adjacent pattern regions PR may contact each other, but the present disclosure is not limited thereto. For example, two adjacent pattern regions PR may be set to be spaced apart from each other. The pattern regions PR may be set in a hexagon shape, but the present disclosure is not limited thereto. For example, the pattern regions PR may be set in a triangle shape, a rectangle shape, an ellipse shape, etc. For example, the shape of a pattern region may be appropriately set depending on the shape of a pattern included in the pattern region.

The measuring unit 121 may be configured to measure pattern information in each of the plurality of pattern regions PR of the pattern image PI and to generate the gauge data GD. In an embodiment, the pattern information may be a critical dimension CD of a hole pattern included in a pattern region. The gauge data GD may include a plurality of gauged values of the critical dimensions of the hole patterns corresponding to the plurality of pattern regions PR.

Referring to FIGS. 2, 3, and 5B, in operation S120, the defect region detection device 120 may generate the color mapping image CMI by mapping a color to each of the plurality of pattern regions PR based on the gauge data GD.

In an embodiment, the color mapping unit 122 may assign different colors to pattern regions having different gauged values from among the plurality of pattern regions PR. For example, within a gradation color range from a first color CL1 corresponding to a first value to a second color CL2 corresponding to a second value, the color mapping unit 122 may assign a color corresponding to a gauged value.

For example, the first color CL1 corresponding to 22 being the first value may be a color including an 8-bit red having a value of “0” and an 8-bit blue having a value of 255, and the second color CL2 corresponding to 28 being the second value may be a color including an 8-bit red having a value of 255 and an 8-bit blue having a value of “0”. In this case, the gradation color range may be a color range from the first color CL1 to the second color CL2, in which a blue value gradually decreases from 255 to 0 and a red value gradually increases from 0 to 255.

For example, when a value increases in units of first decimal place, 60 values may be distributed from 22.0 to 28.0, and whenever the value is increased by 0.1, the value of the red color may be increased by 4, and the value of the blue color may be decreased by 4.

The color mapping unit 122 may assign a color to only a portion of a pattern region. For example, the color mapping unit 122 may map a color corresponding to a gauged value only to a pattern portion of a pattern region, which a hole pattern occupies, and may not assign a color to the remaining portion thereof (e.g., a white color or a black color may be assigned to the remaining portion).

Referring to FIGS. 2, 3, and 5C, in operation S130, the defect region detection device 120 may detect a defective region DR based on the color mapping image CMI.

When a color of a pattern region of the color mapping image CMI belongs to a given range, the defect region determination unit 123 may determine the pattern region as the defective region DR. For example, the defect region determination unit 123 may determine a pattern region whose color range is greater than or equal to a given threshold value, as the defective region DR. In this instance, as the color mapping unit 122 maps a color corresponding to a gauged value only to a pattern portion of the pattern region, the defective region DR is equivalent to a defect pattern (i.e., a defective hole pattern).

In an embodiment, when the color mapping image CMI indicates the gauge data GD by using the gradation color range, the variations in value of the gauge data GD may be classified more finely. Accordingly, in the case of determining defective regions later, defective regions may be subdivided into a region in which a defect is exactly present, a region with a high probability of a defect, a region with a low probability of a defect, etc., and whether a defect exists may be determined for each of the subdivided regions.

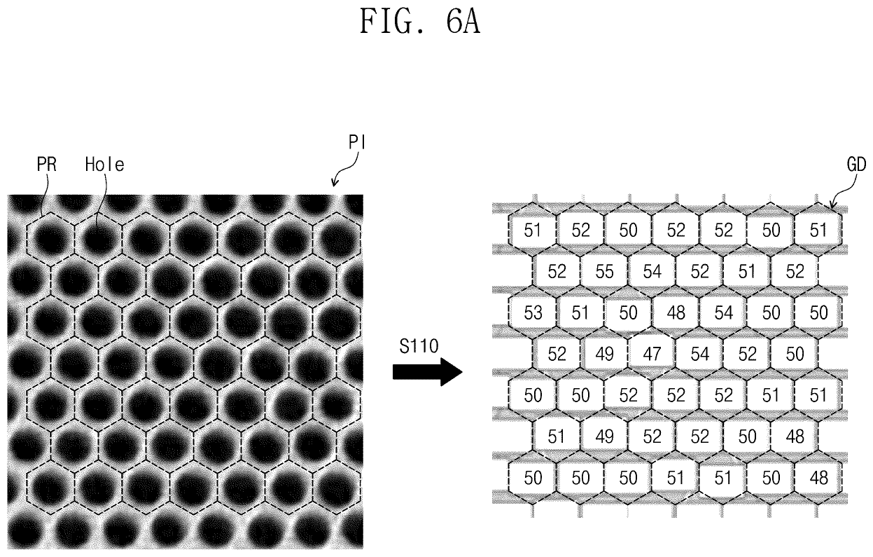

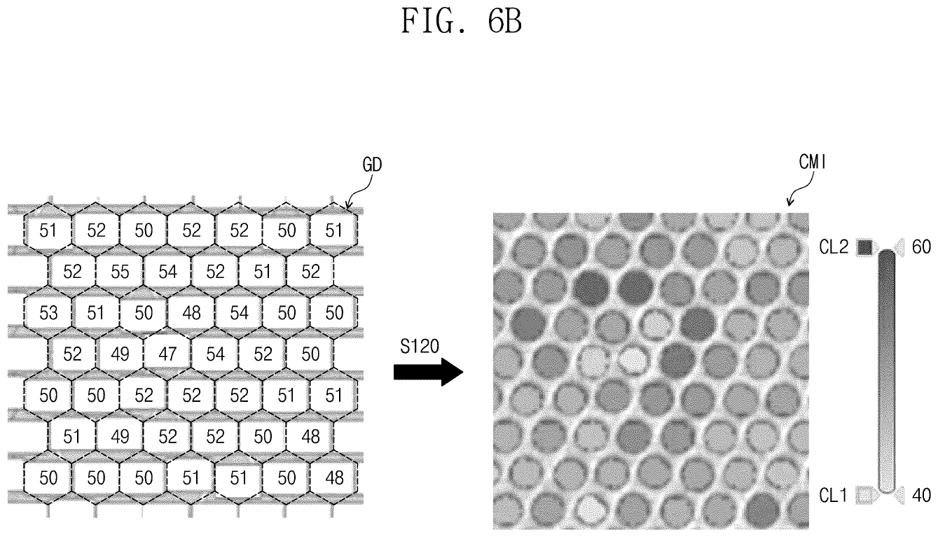

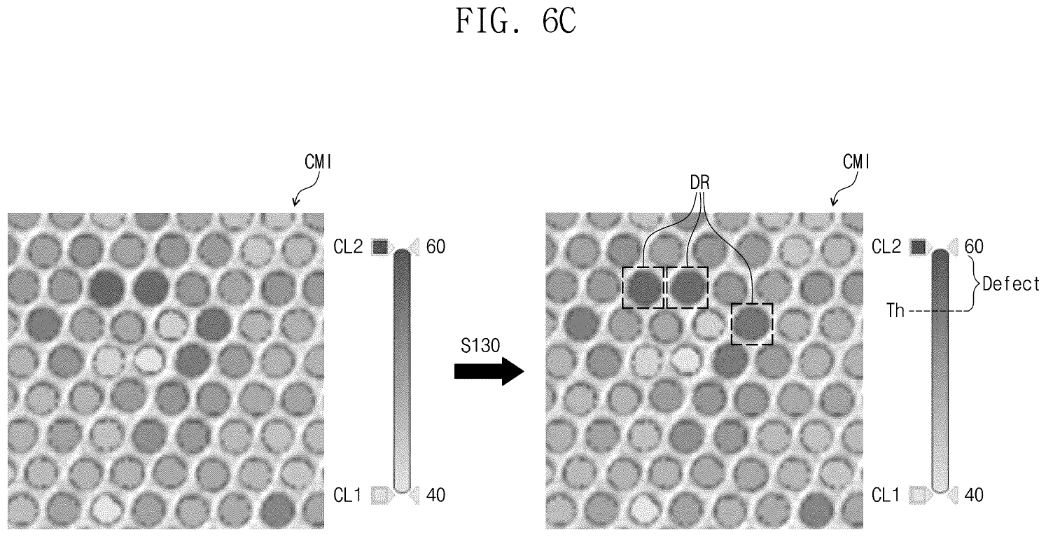

FIGS. 6A to 6C are diagrams illustrating another example of a defect detection method performed for a pattern image of FIG. 4. Below, a difference with the description given with reference to FIGS. 2 to 5C will be mainly described.

In an embodiment, the pattern image PI may include the plurality of hole patterns (refer to FIG. 4).

Referring to FIGS. 2, 3, and 6A, in operation S110, the measuring unit 121 may set the plurality of pattern regions PR based on the pattern image PI, and each of the plurality of pattern regions PR may refer to a unit for measuring pattern information. For example, each pattern region PR may be set to include one hole pattern.

The measuring unit 121 may be configured to measure pattern information in each of the plurality of pattern regions PR of the pattern image PI and to generate the gauge data GD. In an embodiment, the pattern information may be the size of the area of a hole pattern included in a pattern region. The gauge data GD may include a plurality of gauged values each indicating the size of the area of each of the hole patterns corresponding to the plurality of pattern regions PR.

Referring to FIGS. 2, 3, and 6B, in operation S120, the defect region detection device 120 may generate the color mapping image CMI by mapping a color to each of the plurality of pattern regions PR based on the gauge data GD.

For example, the first color CL1 corresponding to 40 being the first value may be a color including an 8-bit red having a value of “0” and an 8-bit blue having a value of 255, and the second color CL2 corresponding to 60 being the second value may be a color including an 8-bit red having a value of 255 and an 8-bit blue having a value of “0”. In this case, the gradation color range may be a color range from the first color CL1 to the second color CL2, in which a blue value gradually decreases from 255 to 0 and a red value gradually increases from 0 to 255.

Referring to FIGS. 2, 3, and 6C, in operation S130, the defect region detection device 120 may detect the defective region DR based on the color mapping image CMI. When a color of a pattern region of the color mapping image CMI belongs to a given range, the defect region determination unit 123 may determine the pattern region as the defective region DR. For example, the defect region determination unit 123 may determine a pattern region whose color range is greater than or equal to a given threshold value, as the defective region DR.

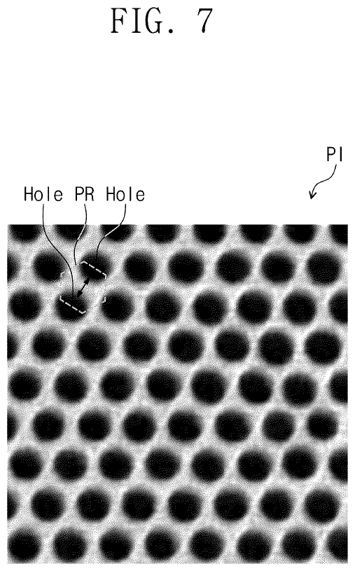

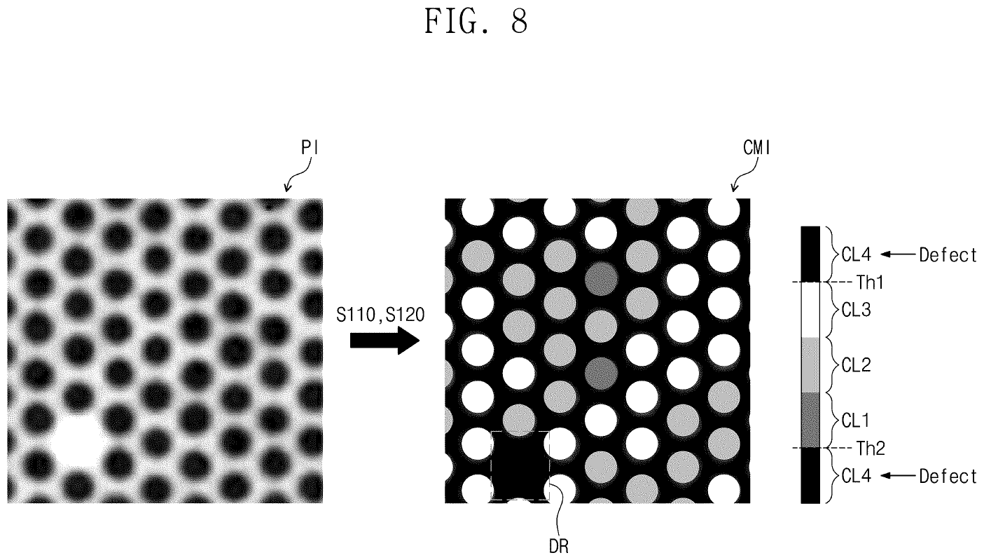

FIG. 7 is a diagram illustrating another example of setting a pattern region in operation S110 of FIG. 3.

Referring to FIG. 7, a pattern region may be set to include a region between two adjacent hole patterns. Only one pattern region is expressed as an example in FIG. 7, but as described above, a pattern region may be provided in plurality, and a shape and an arrangement may be changed to be appropriate for a shape of a pattern to be measured and the arrangement of patterns to be measured.

The measuring unit 121 may measure a pitch between hole patterns of a pattern region and may generate the gauge data GD. Afterwards, the color mapping unit 122 may generate the color mapping image CMI by assigning a color to each of gauged values each indicating a pitch between hole patterns, and the defect region determination unit 123 may determine the defective region DR based on the color mapping image CMI. Operations of the color mapping unit 122 and the defect region determination unit 123 may be performed as described with reference to FIGS. 2 to 6C.

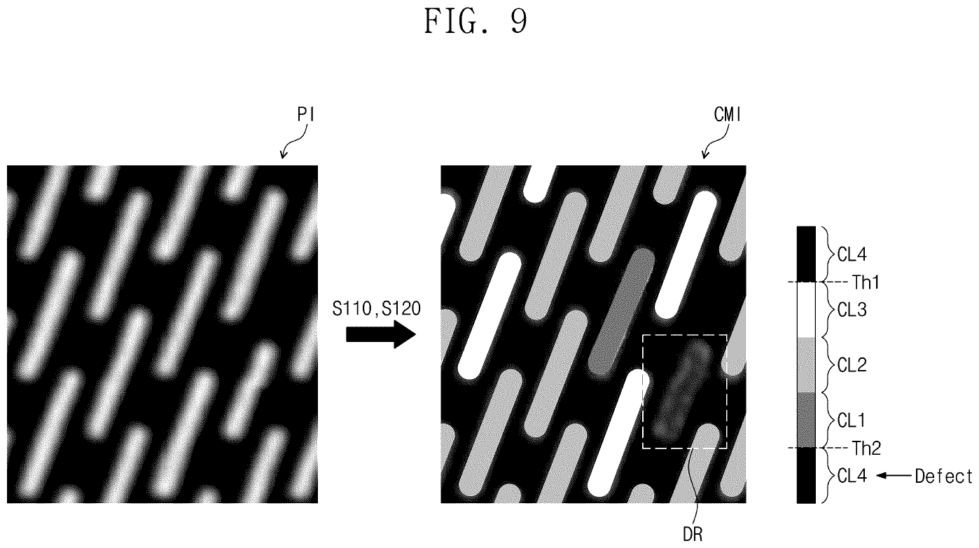

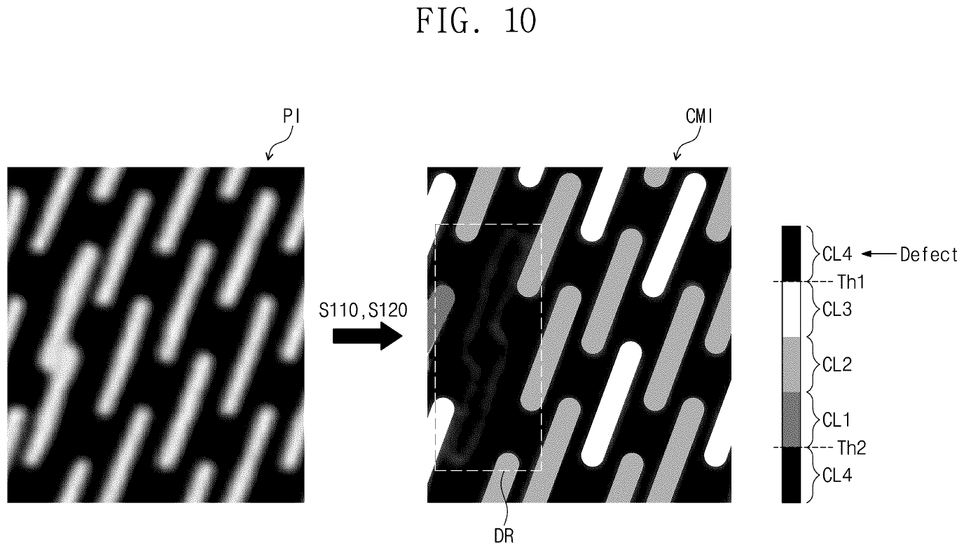

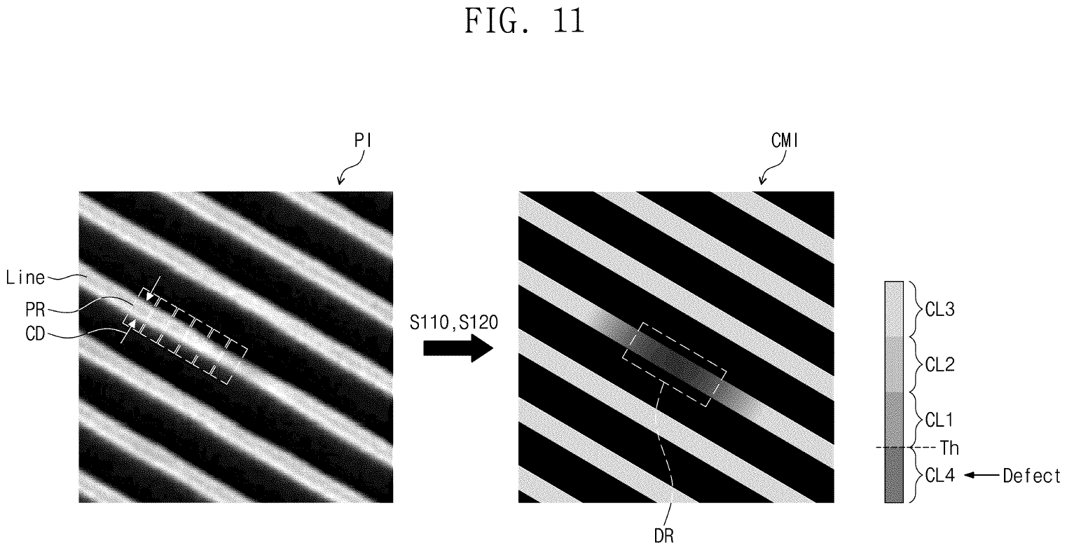

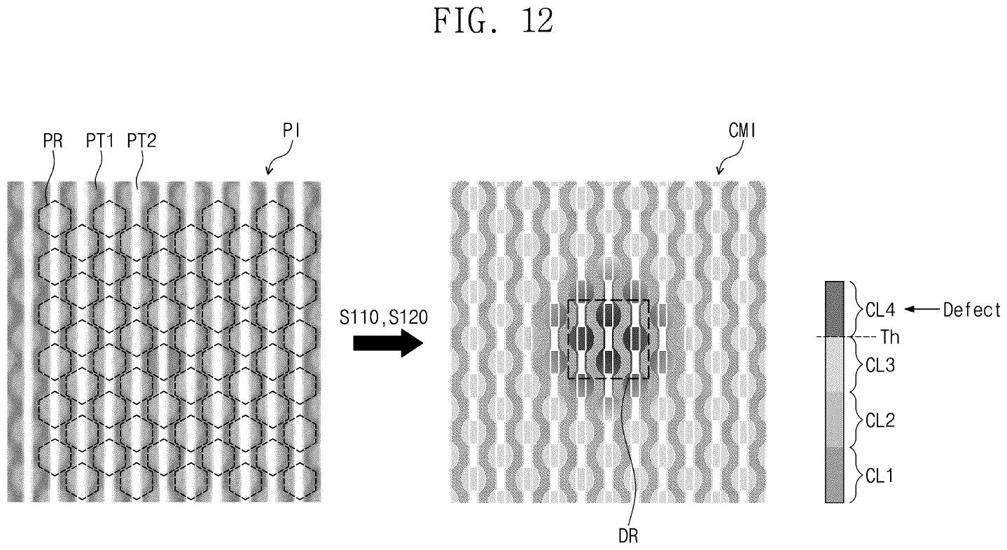

FIG. 8 is a diagram for describing a defect detection method according to an embodiment of the present disclosure. FIG. 9 is a diagram for describing how a defective region is detected in an example of a pattern image, according to an embodiment of the present disclosure. FIG. 10 is a diagram for describing how a defective region is detected in another example of a pattern image, according to an embodiment of the present disclosure. FIG. 11 is a diagram for describing how a defective region is detected in another example of a pattern image, according to an embodiment of the present disclosure. FIG. 12 is a diagram for describing how a defective region is detected in an example of a pattern image, according to an embodiment of the present disclosure. Below, a difference with the description given with reference to FIGS. 2 to 5C will be mainly described.

Referring to FIGS. 2, 3, and 8, the measuring unit 121 may set one or more pattern regions PR based on the pattern image PI, and each of the one or more pattern regions PR may refer to a unit for measuring pattern information. For example, each of the one more pattern regions PR may be set to include one hole pattern and, as similarly discussed above, the measuring unit 121 may generate gauge data GD corresponding to the one or more pattern regions PR. The defect region detection device 120 may measure a plurality of pattern information from the pattern image PI by using the measuring unit 121 and may generate the color mapping image CMI based on the gauge data GD by using the color mapping unit 122.

In an embodiment, the color mapping unit 122 may differently assign a color to a pattern region depending on a range section to which a gauged value belongs. For example, a first color CL1 (i.e., a yellow color) may be assigned to a pattern region whose gauged value belongs to a first range from a first value to a second value (greater than the first value), a second color CL2 (i.e., a light green color) may be assigned to a pattern region whose gauged value belongs to a second range from the second value to a third value (greater than the second value), and a third color CL3 (i.e., a dark green color) may be assigned to a pattern region whose gauged value belongs to a range from the third value to a fourth value (greater than the third value).

In an embodiment, the color mapping unit 122 may assign a color indicating a defect region to a pattern region whose gauged value is greater than or equal to a threshold value. For example, the color mapping unit 122 may set the fourth value as a first threshold value Th1 and may assign a fourth color CL4 (i.e., a black color) indicating a defect region to a pattern region whose gauged value is greater than the fourth value.

In an embodiment, the color mapping unit 122 may assign the color indicating the defect region to a pattern region whose gauged value is smaller than or equal to a threshold value. For example, the color mapping unit 122 may set the first value as a second threshold value Th2 and may assign the fourth color CL4 (i.e., a black color) indicating a defect region to a pattern region whose gauged value is smaller than the first value.

Referring to FIGS. 9 and 10, the pattern image PI may include a plurality of active patterns (Act). An active pattern may correspond to, for example, an active region which is used in the process of manufacturing a DRAM device, but the present disclosure is not limited thereto.

Referring to FIGS. 2, 3, 9, and 10, the measuring unit 121 may set one or more pattern regions PR of the pattern image PI such that at least a portion of an active pattern is included in each of the one or more pattern regions PR and may measure the width of each of the active patterns to generate the gauge data GD about a pattern region. The color mapping unit 122 may assign one of the first to fourth colors CL1 to CL4 to a pattern region based on a gauged value.

Referring to FIG. 9, for example, the color mapping unit 122 may be configured to assign the fourth color CL4 to an active pattern, whose width is measured to be smaller than the second threshold value Th2, from among the plurality of active patterns.

Referring to FIG. 10, for example, the color mapping unit 122 may be configured to assign the fourth color CL4 to an active pattern, whose width is measured to be larger than the first threshold value Th1, from among the plurality of active patterns.

The defect region determination unit 123 may determine a region, to which the fourth color CL4 (i.e., a black color) is assigned, as the defective region DR (i.e., defective pattern).

Referring to FIG. 11, the pattern image PI may include a plurality of line patterns (refer to “Line” of FIG. 11). A line pattern may correspond to, for example, a wiring region for transmitting a power or an electrical signal of a semiconductor element, but the present disclosure is not limited thereto.

The measuring unit 121 may set the pattern regions PR of the pattern image PI such that at least a portion of a line pattern is included in each of the pattern regions PR and may measure the critical dimension (or minimum width) of the line pattern from each of the pattern regions PR to generate the gauge data GD. The color mapping unit 122 may assign one of the first color CL1 (i.e., a yellow color), the second color CL2 (i.e., a light green color), the third color CL3 (i.e., a dark green color), and the fourth color CL4 (i.e., a red color) to a pattern region based on a gauged value.

For example, the color mapping unit 122 may assign the fourth color CL4 to a pattern region, in which a gauged value of the critical dimension of the line pattern is measured to be smaller than a threshold value Th, from among the plurality of pattern regions PR.

The defect region determination unit 123 may determine a region, to which the fourth color CL4 (i.e., a red color) is assigned, as the defective region DR.

Referring to FIG. 12, the pattern image PI may include a plurality of first patterns PT1 and a plurality of second patterns PT2. Each of the first patterns PT1 may be a circular pattern, and each of the second patterns PT2 may be a line pattern. The second pattern PT2 may be provided on the first pattern PT1. In other words, the second pattern PT2 may overlap the first pattern PT1. For example, the first pattern PT1 may be first formed on the wafer, and the second pattern PT2 may be subsequently formed on the wafer.

The measuring unit 121 may set the plurality of pattern regions PR such that each pattern region PR includes one first pattern PT1. Accordingly, each pattern region PR may include the first pattern PT1 and a portion of the second pattern PT2 overlapping the first pattern PT1.

In an embodiment, the measuring unit 121 may measure an overlay value between the first pattern PT1 and the second pattern PT2 in each pattern region PR and may generate the gauge data GD. For example, the measuring unit 121 may measure a distance between a center point of the first pattern PT1 (i.e., the center of the circle) and a center point of the second pattern PT2 (i.e., a center line of a line pattern) in each pattern region PR as a gauged value.

The color mapping unit 122 may assign one of the first color CL1 (i.e., a yellow color), the second color CL2 (i.e., a light green color), the third color CL3 (i.e., a dark green color), and the fourth color CL4 (i.e., a red color) to a pattern region based on a gauged value.

For example, the color mapping unit 122 may assign the fourth color CL4 to a pattern region, in which a gauged value of the critical dimension of the line pattern is measured to be greater than the threshold value Th, from among the plurality of pattern regions PR.

The defect region determination unit 123 may determine a region, to which the fourth color CL4 (i.e., a red color) is assigned, as the defective region DR.

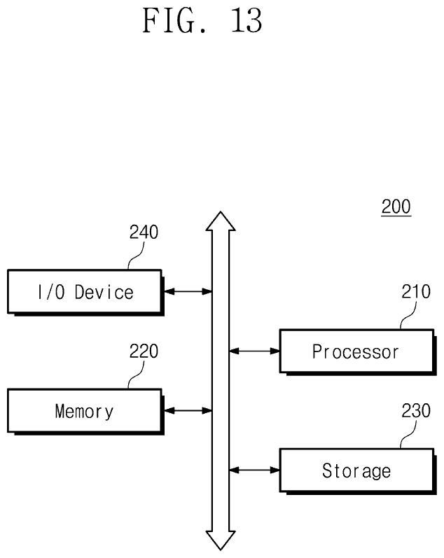

FIG. 13 is a block diagram illustrating an implementation example of a defect region detection device according to an embodiment of the present disclosure.

Referring to FIG. 13, a defect region detection device 200 may include at least one processor 210, a memory 220, storage 230, and an input/output device 240. Herein, the defect region detection device 200 may be provided as a device for executing the defect detection method according to an embodiment of the present disclosure. The defect region detection device 200 may be configured to drive various simulation programs.

The processor 210 may execute software (e.g., an application program, an operating system, and device drivers) which is to be performed by the defect region detection device 200. The processor 210 may execute an operating system (OS) loaded to the memory 220. The processor 210 may execute various application programs which are to be driven based on the operating system. The processor 210 may execute a simulation tool for performing the defect detection method loaded to the memory 220 from the storage 230.

The operating system or the application programs may be loaded to the memory 220. When the defect region detection device 200 is booted up, an operating system (OS) image stored in the storage 230 may be loaded to the memory 220 depending on a booting sequence. All input/output operations of the defect region detection device 200 may be supported by the operating system. Likewise, application programs which are selected by the user or are for providing a basic service may be loaded to the memory 220. In particular, a simulation tool for performing the defect detection method of the present disclosure may also be loaded to the memory 220 from the storage 230.

The simulation tool for performing the defect detection method, when is executed by a processor, may cause the processor to generate the gauge data GD based on the pattern image PI, to assign a color(s) to the pattern image PI based on the gauge data GD to generate the color mapping image CMI, and to determine a defective region, as described with reference to FIGS. 3 to 12.

The memory 220 may include a volatile memory such as a static random access memory (SRAM) or a dynamic random access memory (DRAM). However, the present disclosure is not limited thereto.

The storage 230 is provided as a storage medium of the defect region detection device 200. The storage 230 may store the application programs, the operating system image, and various kinds of data. In particular, the simulation tool for performing the defect detection method according to an embodiment of the present disclosure may be included in the application programs stored in the storage 230.

The simulation tool for performing the defect detection method (refer to FIG. 3) of the present disclosure may be a computer program product including a computer-readable program code or may be a computer program product including a non-transitory computer-usable medium including a computer-readable program code. Additionally or alternatively, the simulation tool for performing the defect detection method of the present disclosure may be a product which is capable of being downloaded over the Internet.

For example, the storage 230 may be provided as a solid state drive (SSD), an embedded multi-media card (eMMC), a hard disk drive (HDD), etc. The storage 230 may include a NAND flash memory. However, the present disclosure is not limited thereto. For example, the storage 230 may include a nonvolatile memory device such as a PRAM, an MRAM, an ReRAM, or an FRAM or a NOR flash memory.

The input/output device 240 may include various devices, which are provided with information from the designer (or operator) or provides information to the designer (or operator), such as a keyboard, a mouse, and a monitor. For example, the shape of a pattern region and the arrangement of pattern regions may be set through the input/output device 240, and a processing process and a processing result may be displayed through the input/output device 240.

According to the present disclosure, a device capable of easily checking a defective region on a wafer is provided.

While the present disclosure has been described with reference to embodiments thereof, it will be apparent to those of ordinary skill in the art that various changes and modifications may be made thereto without departing from the spirit and scope of the present disclosure as set forth in the following claims.

1. A defect region detection device comprising:
a measuring unit configured to generate gauge data, based on a pattern image including a plurality of pattern regions, by measuring pattern information in one or more of the pattern regions; and
a color mapping unit configured to generate a color mapping image, based on the pattern image and the gauge data, by mapping a color corresponding to the gauge data to the one or more pattern regions,
wherein the defect region detection device is configured to detect a defective region based on the color assigned to the one or more pattern regions of the color mapping image.

2. The defect region detection device of claim 1, wherein the color mapping unit is configured to assign a color, corresponding to a gauged value of the gauge data to each of the one or more pattern regions, from among a plurality of colors,
wherein the gauged value of the gauge data is included in a range from a first value to a second value, and
wherein the plurality of colors are within a gradation color range from a first color corresponding to the first value to a second color corresponding to the second value.

3. The defect region detection device of claim 1, wherein the color mapping unit is configured to assign a first color indicating a defect region to a pattern region included in the one or more pattern regions,
wherein the first color corresponds to a first gauged value of the gauge data, and
wherein the first gauged value is greater than or equal to a threshold value.

4. The defect region detection device of claim 1, wherein each of the one or more pattern regions includes a hole pattern, and
wherein the gauge data includes a gauged value indicating a critical dimension of the hole pattern.

5. The defect region detection device of claim 1, wherein each of the one or more pattern regions includes a hole pattern, and
wherein the gauge data includes a gauged value indicating a size of the hole pattern.

6. The defect region detection device of claim 1, wherein each of the one or more pattern regions includes a region between two hole patterns adjacent to each other, and
wherein the gauge data includes a gauged value indicating a pitch between the two hole patterns.

7. The defect region detection device of claim 1, wherein at least one of the one or more pattern regions includes a line pattern, and
wherein the gauge data includes a gauged value indicating a critical dimension of the line pattern.

8. The defect region detection device of claim 1, wherein the gauge data includes a gauged value indicating a size of an area occupied by each of the one or more pattern regions, and
wherein the color mapping unit is configured to assign a first color indicating a defect region to a first pattern region included in the one or more pattern regions,
wherein the first color corresponds to a first gauged value of the gauge data, and
wherein the first gauged value is smaller than a first threshold value and is greater than or equal to a second threshold value.

9. The defect region detection device of claim 1, wherein one of the one or more pattern regions includes at least a portion of a first pattern and at least a portion of a second pattern overlapping the first pattern, and
wherein the gauge data includes a gauged value indicating an overlay between the first pattern and the second pattern.

10. A wafer defect detection system comprising:
a measurement device configured to obtain a scanning electron microscope (SEM) image by scanning a wafer with a beam of electrons; and
a defect region detection device configured to detect a defect of a pattern formed on the wafer based on the SEM image,
wherein the defect region detection device includes:
a measuring unit configured to generate gauge data, based on a pattern image including a plurality of pattern regions, by measuring pattern information in one or more of the pattern regions; and
a color mapping unit configured to generate a color mapping image, based on the pattern image and the gauge data, by mapping a color corresponding to the one or more of pattern regions.

11. The wafer defect detection system of claim 10, wherein the measurement device is a SEM device, and
wherein the SEM image is a gray scale image.

12. The wafer defect detection system of claim 10, wherein the color mapping unit is configured to assign a color, corresponding to a gauged value of the gauge data to each of the one or more pattern regions, from among a plurality of colors,
wherein the gauged value of the gauge data is included in a range from a first value to a second value, and
wherein the plurality of colors are within a gradation color range from a first color corresponding to the first value to a second color corresponding to the second value.

13. The wafer defect detection system of claim 10, wherein the color mapping unit is configured to assign a first color indicating a defect region to a pattern region included in the one or more pattern regions,
wherein the first color corresponds to a first gauged value of the gauge data, and
wherein the first gauged value is greater than or equal to a threshold value.

14. The wafer defect detection system of claim 10, wherein each of the one or more pattern regions includes a hole pattern, and
wherein the gauge data includes a gauged value indicating a critical dimension of the hole pattern.

15. The wafer defect detection system of claim 10, wherein each of the one or more pattern regions includes a hole pattern, and
wherein the gauge data includes a gauged value indicating a size of the hole pattern.

16. The wafer defect detection system of claim 10, wherein each of the one or more pattern regions includes a region between two hole patterns adjacent to each other, and
wherein the gauge data includes a gauged value indicating a pitch between the two hole patterns.

17. A computer program stored in a storage medium, when is executed by a computer, causing the computer to:
measure pattern information in one or more pattern regions based on a pattern image including the one or more pattern regions to generate gauge data;
map a color corresponding to the gauge data to each of the one or more pattern regions based on the pattern image and the gauge data to generate a color mapping image; and
detect a defective region based on the color assigned to each of the one or more pattern regions of the color mapping image.

18. The computer program of claim 17, wherein the computer program, when is executed, further causes the computer to assign a color, corresponding to a gauged value of the gauge data to each of the one or more pattern regions, from among a plurality of colors,
wherein the gauged value of the gauge data is included in a range from a first value to a second value, and
wherein the plurality of colors are within a gradation color range from a first color corresponding to the first value to a second color corresponding to the second value.

19. The computer program of claim 17, wherein the computer program, when is executed, further causes the computer to assign a first color indicating a defect region to a pattern region included in the one or more pattern regions,
wherein the first color corresponds to a first gauged value of the gauge data, and
wherein the first gauged value is greater than or equal to a threshold value.

20. The computer program of claim 17, wherein each of the one or more pattern regions includes a hole pattern, and
wherein the gauge data includes a gauged value indicating a critical dimension of the hole pattern.
